(19) United States
(12) Patent Application Publication
(10) Pub. No.: US 2022/0389229 A1
(43) Pub. Date: Dec. 8, 2022

(54) Method For Producing Surface-Coated Hexagonal Boron Nitride Particle And Surface-Coated Hexagonal Boron Nitride Particle

(71) Applicant: 3M INNOVATIVE PROPERTIES COMPANY, St. Paul, MN (US)

(72) Inventors: Keita Matsuda, Toki-city (JP); Taiki Ihara, Tokyo (JP); Ricardo Gorgoll, Kanagawa (JP)

(21) Appl. No.: 17/664,940

(22) Filed: May 25, 2022

(30) Foreign Application Priority Data
May 31, 2021 (JP) 2021-091314

(51) Int. Cl. C09C 3/08; C01B 21/064

(52) U.S. Cl. CPC C09C 3/08; C01B 21/0648; C01P 2004/20; C01P 2004/03

(57) ABSTRACT

Provided is a method for effectively modifying a surface of a h-BN particle including a (0001) plane, which is a base surface of h-BN, with a variety of materials.

A method for producing a surface-coated hexagonal boron nitride particle of one embodiment includes mixing a hexagonal boron nitride particle (a), a coupling agent (b), and a catalyst (c) having a polar group and an aromatic ring in a solvent to form a layer containing a condensate of the coupling agent on at least a portion of a surface of the hexagonal boron nitride particle.

### TECHNICAL FIELD

The present disclosure relates to a method for producing a surface-coated hexagonal boron nitride particle, and a surface-coated hexagonal boron nitride particle. The present disclosure also relates to a heat-dissipating resin composition containing such a surface-coated hexagonal boron nitride particle.

### BACKGROUND ART

Since hexagonal boron nitride (hereinafter, referred to as “h-BN” also) has high thermal conductivity and insulating properties, it is promising for applications such as thermal management of electronic parts for automobiles, power semiconductors, and fifth generation mobile communication systems (5G). Hexagonal boron nitride has a layered (lamellar) structure similar to that of graphite, and is chemically inert and stable, so that h-BN is also used as a cosmetic slip improver, a matting agent, a brightener, and the like. Hexagonal boron nitride is provided in various forms of particles, such as flat plate, agglomerates, flakes, and the like. It has been known to modify a surface of a h-BN particle depending on the application.

Patent Document 1 (JP 2008-94701 A) discloses “a boron nitride composition containing a boron nitride powder, wherein the boron nitride powder is surface-treated with at least an organic silicone compound having a formula selected from (RR′ SiO—)ₙ (where R and R′ are the same or different and are selected from the group of H, alkyl, aryl, and substituted aryl, and n is a value in the range of 3 to 16 for cyclic compounds and 2 to 1 million for linear compounds), and NHₙ(SiR₁R₂R₃)₃, (where R₁, R₂, and R₃ are hydrocarbyl groups or H, and n is 1 or 2).” In Patent Document 1, optionally, firing, grinding, or coating is performed to increase the reaction site of the boron nitride surface.

Patent Document 2 (JP 2007-182369 A) discloses “a boron nitride composition containing a boron nitride powder, wherein a surface of the boron nitride powder is treated with at least an overcoating layer containing at least one of silane, siloxane, a carboxylic acid derivative, and a mixture thereof, the overcoating layer having at least one reactive functional group, and the overcoating coating layer adhering to at least 2% of the surface of the boron nitride”. In Patent Document 2, optionally, surface oxidation by firing, or coating is performed to increase the reaction site of the boron nitride surface.

Non-Patent Document 1 (Ceramics International 42 (2016) 6312-6318) discloses that a surface of hexagonal boron nitride (h-BN) is modified with perfluorooctyltriethoxysilane (FTS). FIG. 4 schematically illustrates a mechanism in which FTS molecules are bonded to a surface of a h-BN nanoparticle, and an ethoxy group of FTS and a hydroxyl group (B—OH) at a terminal of the h-BN surface are subjected to ethanol condensation to modify an end portion of the h-BN surface.

Non-Patent Document 2 (Ceramics International 40 (2014) 2047-2056) discloses a composite material of an epoxy-terminated dimethylsiloxane matrix and a boron nitride powder filler. As illustrated in FIG. 1, the boron nitride powder filler is treated in an aqueous sodium hydroxide solution to introduce a hydroxyl group (B—OH) at a terminal, and the hydroxyl group reacts with 3-glycidoxypropyltrimethoxysilane to modify an end portion of the surface of the boron nitride powder filler.

Non-Patent Document 3 (Journal of the Ceramic Society of Japan 123 [5] 423-427 2015) discloses coating a flat-plate powder of hexagonal boron nitride with SiO₂ nanolayers using rotary chemical vapor deposition (RCVD). In the RCVD process, tetraethyl orthosilicate as a precursor is heated to 110° C., introduced into a reactor, and reacted with oxygen at 700° C. to form SiO₂. As illustrated in FIG. 4 for the coating of the SiO₂ nanolayer, since the hexagonal boron nitride powder is maintained in a floating state by a rotational movement of a reactor, the entire surface of the powder is exposed to a reaction gas, and the dense SiO₂ nuclei uniformly adhere to the surface of the hexagonal boron nitride. However, when a precursor supply rate is too high, the dense SiO₂ nuclei are not formed, and lumps and protrusions are formed.

Non-Patent Document 4 (Materials and Design 182 (2019) 108028) discloses that hexagonal boron nitride is introduced into a polymer insulating filler (polyphenylene ether resin) of a copper clad laminate. The hexagonal boron nitride is dispersed in a medium containing ammonia and deionized water using ultrasonic waves and is coated with a condensate of tetraethyl orthosilicate. According to Non-Patent Document 4, as illustrated in FIG. 2(a), in tetraethyl orthosilicate, a hydroxyl group and an amino group are generated at an end portion of a lamellar structure, and orthosilicic acid generated by hydrolysis reaction of tetraethyl orthosilicate is preferentially dehydration-condensed at an end portion of hexagonal boron nitride to form a silica nucleus. After the end portion is completely coated with silica, the silica coating gradually moves to the smooth surface of the hexagonal boron nitride, and finally the entire hexagonal boron nitride is coated with silica.

Non-Patent Document 5 (Composites Part A 137 (2020) 106026) discloses a thermally conductive composite material in which a covalent bond is formed between silane coupling agent-coupled poly(vinyl alcohol) and functionalized boron nitride. The functionalized boron nitride is obtained by dispersing a hexagonal boron nitride powder in a mixture of isopropanol and deionized water while applying ultrasonic waves, and removing a non-cutting boron nitride sheet, and specifically, a hydroxyl group (B—OH) is introduced at the terminal of boron nitride. The composite material illustrated in FIG. 3 is obtained by reacting the hydroxyl group of boron nitride and the hydroxyl group of poly(vinyl alcohol) with tetraethyl orthosilicate, vinyltriethoxysilane, or 3-glycidoxypropyltrimethoxysilane.

Non-Patent Document 6 (ACS Appl. Mater. Interfaces 2015, 7, 10, 5915-5926) discloses non-covalent modification of hexagonal boron nitride nanoparticles with polydopamine under aqueous conditions free of organic solvents and incorporation of bisphenol E cyanate esters into modified hexagonal boron nitride nanoparticles.

### PRIOR ART DOCUMENT

### Patent Document

Patent Document 1: JP 2008-94701 A
Patent Document 2: JP 2007-182369 A

### Non-Patent Document

Non-Patent Document 1: Ceramics International 42 (2016) 6312-6318
Non-Patent Document 2: Ceramics International 40 (2014) 2047-2056
Non-Patent Document 3: Journal of the Ceramic Society of Japan 123 [5] 423-427 2015
Non-Patent Document 4: Materials and Design 182 (2019) 108028
Non-Patent Document 5: Composites Part A 137 (2020) 106026
Non-Patent Document 6: ACS Appl. Mater. Interfaces 2015, 7, 10, 5915-5926

### SUMMARY

### Problems to be Solved by the Invention

Since h-BN particles are generally less flowable, it may be difficult to handle during production.

Since h-BN has a layered structure, for example, when a resin is used as a matrix in a composite material, the viscosity of the composite material tends to increase. Since the h-BN is chemically inert, it is difficult to mix the h-BN with the resin, and it is also difficult to reduce the viscosity of the composite material even when a dispersion auxiliary is added.

The h-BN is an anisotropic thermally conductive material. When the composite material containing the flat-plate h-BN particles is coated, the orientation of the flat-plate h-BN particles is aligned by a shear force applied at that time, and the thermal conductivity in the thickness direction of the coating may be particularly low.

In the known surface modification method, an end portion of a lamellar structure mainly of the h-BN is modified. In the h-BN, boron atoms and nitrogen atoms in the same layer are strongly bonded to each other, but adjacent layers are held by weak van der Waals forces. Therefore, a dangling bond hardly exists on the (0001) plane which is a base surface. This is why surface modification of the h-BN (and graphite) is difficult, especially in the base surface. The end portion of the lamellar structure is only a part of the entire surfaces of the h-BN particles, particularly the flat-plate h-BN particles, and it is difficult to effectively modify the (0001) plane occupying most of the surfaces of the h-BN particles by a simple method. For example, the surface modification disclosed in Non-Patent Document 3 requires an RCVD apparatus and a high temperature and reduced pressure (700° C., 800 Pa) environment.

It is also possible to generate a hydroxyl group as a dangling bond on the base surface of h-BN by an ozone treatment, a corona treatment, a plasma treatment, or the like, and perform surface treatment using the hydroxyl group as an anchor. However, these types of treatments may disrupt the structure of h-BN to reduce the physical properties, particularly thermal conductivity of the h-BN particles, which may require special equipment. When the h-BN particles are pulverized in order to expose an active surface for the surface modification treatment, it is difficult to accurately obtain the h-BN particles having a desired particle size distribution.

The present disclosure provides a method for producing a surface-coated hexagonal boron nitride particle capable of effectively modifying a (0001) plane, which is a base surface of h-BN, using a convenient approach, with various materials. The present disclosure also provides a surface-coated h-BN particle having a (0001) plane modified with high coverage.

### Solutions to Problems

According to an embodiment of the present disclosure, there is provided a method for producing a surface-coated hexagonal boron nitride particle, the method including mixing a hexagonal boron nitride particle (a), a coupling agent (b), and a catalyst (c) having a polar group and an aromatic ring in a solvent to form a layer containing a condensate of the coupling agent on at least a portion of a surface of the hexagonal boron nitride particle.

According to another embodiment of the present disclosure, there is provided a surface-coated hexagonal boron nitride particle including a layer containing a condensate of a coupling agent and formed on at least a portion of a surface of a hexagonal boron nitride particle, wherein the surface of the hexagonal boron nitride particle includes at least a portion of a (0001) plane.

According to still another embodiment of the present disclosure, there is provided a surface-coated hexagonal boron nitride particle including a layer containing a condensate of a coupling agent (b) and formed on at least a portion of a surface of a hexagonal boron nitride particle (a) by mixing the hexagonal boron nitride particle (a), the coupling agent (b), and a catalyst (c) having a polar group and an aromatic ring in a solvent.

According to yet another embodiment of the present disclosure, there is provided a heat-dissipating resin composition including a surface-coated hexagonal boron nitride particle, wherein the surface-coated hexagonal boron nitride particle has a layer containing a condensate of a coupling agent and formed on at least a portion of a surface of the hexagonal boron nitride particle, and the surface of the hexagonal boron nitride particle includes at least a portion of a (0001) plane.

### Effects of the Invention

According to the method for producing a surface-coated hexagonal boron nitride particle of the present disclosure, it is possible to effectively modify the (0001) plane, which is a base surface of h-BN, by a simple technique of mixing a h-BN particle, a coupling agent, and a catalyst in a solvent. Since the method of the present disclosure does not require special production equipment, it is possible to reduce costs related to investment and operation of the production equipment. In addition, the method of the present disclosure, in which various coupling agents can be used, can thus improve the properties of the h-BN particles, such as further improved hydrophobization, hydrophilization, and oxidation resistance depending on the purpose, or impart new properties to the h-BN particles.

The surface-coated hexagonal boron nitride particle of the present disclosure has a modified surface including a (0001) plane, and thus, it is excellent in fluidity and miscibility with other materials and can be used in various applications as a raw material of a composite material such as a heat-dissipating resin composition.

The foregoing description should not be construed as disclosing all aspects of the disclosure and all advantages thereof.

### BRIEF DESCRIPTION OF THE DRAWINGS

FIGS. 1(a) to 1(c) are SEM photographs (upper row: magnification 10,000, lower row: magnification 100,000) of untreated h-BN particles (CFA 150, agglomerates) (a), and surface-coated h-BN particles in Example 4 (b) and Example 5 (c).

FIGS. 2(a) to 2(g) are SEM photographs (in upper frame: magnification 3,000, background: magnification 15,000, 30,000, or 100,000) of untreated h-BN particles (P015, primary particles) (a), and surface-coated h-BN particles in Example 16 (b), Example 17 (c), Example 18 (d), Example 19 (e), Example 20 (f), and Example 21 (g).

FIGS. 3(a) to 3(c) are SEM photographs (upper row: magnification 300 or 1,000, lower row: magnification 30,000) of surface-coated h-BN particles in Comparative Example 7 (a), Comparative Example 8 (b), and Example 5 (c).

### DETAILED DESCRIPTION

Hereinafter, for the purpose of illustrating representative embodiments of the present invention, the present invention will be described in more detail with reference to the drawings as necessary, but the present invention is not limited to these embodiments.

In the present disclosure, a “sheet” also includes an article called a “film”.

In the present disclosure “(meth)acrylic” means acrylic or methacrylic.

A method for producing a surface-coated hexagonal boron nitride particle of one embodiment includes mixing a hexagonal boron nitride particle (a), a coupling agent (b), and a catalyst (c) having a polar group and an aromatic ring in a solvent to form a layer containing a condensate of the coupling agent on at least a portion of a surface of the hexagonal boron nitride particle.

In this embodiment, a catalyst having a polar group and an aromatic ring is used as a catalyst for forming the condensate of the coupling agent. Without being bound by any theory, in a state in which the aromatic ring of the catalyst has a π-π stacking interaction with the (0001) plane of the h-BN particle, the polar group of the catalyst promotes a condensation reaction of the coupling agent and, optionally, a hydrolysis reaction prior to the condensation reaction. Thus, the condensate of the coupling agent is formed in proximity to the (0001) plane of the h-BN particle at a distance of a molecular level of the catalyst. With this, the surface including the (0001) plane of the h-BN particle can be effectively covered with the condensate of the coupling agent. By selecting, as the polar group of the catalyst, a group suitable for the condensation reaction and optionally the hydrolysis reaction of the coupling agent, the surface of the h-BN particle can be coated using various coupling agents.

The form of the hexagonal boron nitride (h-BN) particles may vary and is not particularly limited. Examples of the form of the h-BN particles include primary particles of a needle shape and a flat-plate shape, and an agglomerate of these primary particles. The h-BN particles can be used alone or in combination of two or more.

The size of the primary particle may be appropriately selected to obtain characteristics desired for the intended use, for example, thermal conductivity, and is not particularly limited. An average major diameter of the primary particles can be approximately 1.5 μm or more, approximately 2.0 μm or more, or approximately 2.5 μm or more, and approximately 25 μm or less, approximately 20 μm or less, or approximately 15 μm or less. In the present disclosure, the average major diameter of the primary particles is defined as an average value of major diameters of 50 primary particles in an image obtained using a microscope such as an optical microscope, a scanning electron microscope (SEM), or a transmission electron microscope (TEM).

The size of the agglomerate may be appropriately selected to obtain characteristics desired for the intended use, for example, thermal conductivity, and is not particularly limited. An average particle diameter of the agglomerates can be approximately 20 μm or more, approximately 40 μm or more, or approximately 60 μm or more, and approximately 300 μm or less, approximately 250 μm or less, or approximately 200 μm or less. In the present disclosure, the average particle diameter of the agglomerates is defined as an average value of area circle equivalent particle diameters of 50 agglomerates in an image obtained using a microscope such as an optical microscope, a scanning electron microscope (SEM), or a transmission electron microscope (TEM). The area circle equivalent particle diameter is a particle diameter when converted into a circular particle having the same area as the projected area of the agglomerates on the image.

In one embodiment, the h-BN particles are flat-plate primary particles. The flat-plate h-BN primary particles can impart thermal conductivity, lubricity, glossiness, and the like to the composite material.

In another embodiment, the h-BN particle is an agglomerate of the primary particles. The agglomerate of the h-BN primary particles is excellent in processibility and can impart high thermal conductivity to the composite material because the primary particles are randomly oriented.

The coupling agent is generally a reagent that is interposed between two materials having different chemical properties, for example, at an interface between an inorganic material and an organic material, and contributes to bonding, mixing, and the like of these materials. The coupling agent is not particularly limited provided it can form a layer on the surface of the h-BN particle by forming a condensate containing a semimetal or a metal. The coupling agents can be used alone or in combination of two or more.

In one embodiment, the coupling agent contains at least one element selected from the group consisting of aluminum, silicon, titanium, and zirconium.

Examples of the aluminum coupling agent include aluminum ethylate, aluminum isopropylate, aluminum diisopropylate monosec-butyrate, aluminum ethylacetoacetate diisopropylate, aluminum monoacetylacetonate bis(ethylacetoacetate), aluminum octadecenyl acetoacetate diisopropylate, aluminum tris(acetylacetonate), cyclic aluminum oxide isopropylate, cyclic aluminum oxide stearate, and cyclic aluminum oxide octylate. The aluminum coupling agent is preferably aluminum monoacetylacetonate bis(ethyl acetoacetate).

Examples of the silicon coupling agent include alkoxysilanes such as methyltrimethoxysilane, dimethyldimethoxysilane, phenyltrimethoxysilane, dimethoxydiphenylsilane, tetraethoxysilane (tetraethyl orthosilicate), methyltriethoxysilane, dimethyldiethoxysilane, phenyltriethoxysilane, n-propyltrimethoxysilane, n-propyltriethoxysilane, hexyltrimethoxysilane, hexyltriethoxysilane, octyltriethoxysilane, isooctyltrimethoxysilane, decyltrimethoxysilane, 3,3,3-trifluoropropyltrimethoxysilane, and hexamethyldisilazane; vinyl-modified silanes such as vinyltrimethoxysilane and vinyltriethoxysilane; epoxy-modified silanes such as 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, and 3-glycidoxypropyltriethoxysilane; styrene-modified silanes such as p-styryltrimethoxysilane; (meta)acrylic modified silanes such as 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane; amino-modified silanes such as N-2-(aminoethyl)-3-aminopropylmethyldimethoxysilane, N-2-(aminoe thyl)-3-aminopropyltrimethoxysilane, N-2-(aminoethyl)-3-aminopropyltriethoxysilane, 3-aminopropyltrimethoxysilane, and 3-aminopropyltriethoxysilane; isocyanurate-modified silanes such as tris-(trimethoxysilylpropyl) isocyanurate; ureid-modified silanes such as 3-ureidopropyltrialkoxysilane; mercapto-modified silanes such as 3-mercaptopropylme thyldimethoxysilane and 3-mercaptopropyltrimethoxysilane; isocyanate-modified silanes such as 3-isocyanate propyltriethoxysilane; and acid anhydride modified silanes such as 3-trimethoxysilylpropyl succinic anhydride. The silicon coupling agent is preferably tetraethyl orthosilicate, 3-acryloxypropyltrimethoxysilane, or isooctyltrimethoxysilane.

Examples of the titanium coupling agent include titanium tetraethoxide, titanium tetraisopropoxide, titanium tetra n-butoxide, titanium n-butoxide dimer, titanium tetra(2-ethylhexoxide), titanium diisopropoxy bis(acetylacetonate), titanium tetraacetylacetonate, titanium diisopropoxybis(ethylacetoacetate), titanium lactate and ammonium salts thereof, and titanium diisopropoxy bis(triethanolaminate). The titanium coupling agent is preferably titanium tetraacetylacetonate, titanium diisopropoxy bis(acetylacetonate), or titanium diisopropoxy bis(ethyl acetoacetate).

Examples of the zirconium coupling agent include zirconium tetra n-propoxide, zirconium tetra n-butoxide, zirconium tetraacetylacetonate, zirconium tri n-butoxy monoacetylacetonate, zirconium di n-butoxy bisethyl acetoacetate, and zirconium tetraacetylacetonate. The zirconium coupling agent is preferably zirconium tri n-butoxy monoacetylacetonate, zirconium di n-butoxy bisethyl acetoacetate, or zirconium tetra n-butoxide.

The amount of the coupling agent used is generally approximately 5 parts by mass or more, approximately 10 parts by mass or more, or approximately 20 parts by mass or more, and approximately 70 parts by mass or less, approximately 60 parts by mass or less, or approximately 40 parts by mass or less with respect to 100 parts by mass of the h-BN particles.

The catalyst having a polar group and an aromatic ring is not particularly limited as long as the polar group promotes the condensation reaction and optionally the hydrolysis reaction of the coupling agent. The catalyst may have two or more polar groups and two or more aromatic rings in one molecule. The catalyst can be used alone or in combination of two or more.

Examples of the polar group of the catalyst include an amino group, a hydroxyl group, a sulfone group, and a phosphate group. The polar group of the catalyst is preferably an amino group. Without being bound by any theory, a catalyst having an amino group as a polar group is capable of interacting with the surface of h-BN particles not only through an aromatic ring but also through an amino group. By the interaction between the amino group and the surface of the h-BN particle, after the catalyst approaches the surface of the h-BN particle, the aromatic ring of the catalyst has a π-π stacking interaction with the (0001) plane of the h-BN particle, and the amino group that has become free promotes the condensation reaction and optionally the hydrolysis reaction of the coupling agent. By such a mechanism, it is considered that the catalyst having an amino group as a polar group in a smaller amount can effectively form a layer containing a condensate of a coupling agent on the surface of h-BN particle.

Examples of the aromatic ring of the catalyst include aromatic hydrocarbon rings such as a benzene ring, a naphthalene ring, an anthracene ring, a phenanthrene ring, and a pyrene ring, and heteroaromatic rings such as a furan ring, a thiophene ring, a pyrrole ring, a pyrazole ring, an imidazole ring, and a pyridine ring. The number of atoms constituting an aromatic ring structure can be 5 or more, or 6 or more, and 22 or less, 16 or less, or 10 or less. The aromatic ring of the catalyst is preferably a benzene ring. Since the catalyst having a benzene ring as an aromatic ring has a relatively small molecular weight, the solubility in a solvent is high, and the pH can be increased with a small amount to promote the condensation reaction and optionally the hydrolysis reaction of the coupling agent.

The aromatic ring may have a substituent or may be unsubstituted. Examples of the substituent of the aromatic ring include alkyl groups such as a methyl group, an ethyl group, a n-propyl group, an isopropyl group, a n-butyl group, an isobutyl group, a sec-butyl group, and a tert-butyl group; alkoxy groups such as a methoxy group and an ethoxy group; and halogen atoms such as fluorine, chlorine, bromine, and iodine.

Specific examples of the catalyst include 1,3-bis(aminomethyl)benzene (m-xylylenediamine), benzylamine, 3-aminobenzylamine, and 1,4-bis(aminomethyl)benzene. The catalyst is preferably 1,3-bis(aminomethyl)benzene, 3-aminobenzylamine, or 1,4-bis(aminomethyl)benzene, and more preferably 1,3-bis(aminomethyl)enzene.

The amount of the catalyst used is not particularly limited provided the condensation reaction and optionally the hydrolysis reaction of the coupling agent can be promoted and can be appropriately determined according to the type of the catalyst to be used, the type and amount of the solvent used, and the like. For example, when a catalyst having an amino group as a polar group is used, it is advantageous to determine the amount of the catalyst used so that the pH of a mixture containing the h-BN particle, the coupling agent, and the catalyst in a solvent is approximately 9 or more and approximately 10 or less.

The surface-coated h-BN particle is produced by mixing the h-BN particle, the coupling agent, and the catalyst in the solvent. In this mixing step, a layer containing the condensate of the coupling agent is formed on at least a portion of the surface of the h-BN particle.

The solvent is not particularly limited provided it does not adversely affect the condensation reaction of the coupling agent and the condensate generated thereby. The solvent can be used alone or in combination of two or more.

Examples of the solvent include water such as distilled water and deionized water; alcohols such as methanol and ethanol; ketones such as acetone, methyl ethyl ketone, and methyl isobutyl ketone; esters such as ethyl acetate and butyl acetate; sulfoxides such as dimethyl sulfoxide; amides such as dimethylformamide and dimethylacetamide; aliphatic hydrocarbons such as pentane, hexane, and heptane; and aromatic hydrocarbons such as toluene and xylene. In the case of the coupling agent that requires the hydrolysis reaction prior to the condensation reaction of the coupling agent, it is preferable to use water or a mixed solvent of water and alcohol.

The amount of the solvent used can be appropriately determined according to the fluidity of a mixture containing the h-BN particle, the coupling agent, and the catalyst in the solvent. It is desirable that the fluidity of the mixture is within a range that does not interfere with stirring.

The mixing can be performed using a general mixing device. Examples of the mixing device include a mix rotor, a stirrer, and a magnetic stirrer.

The order of charging the h-BN particle, the coupling agent, and the catalyst into the mixing device is not particularly limited. For example, after the h-BN particles are dispersed in the solvent, the coupling agent and the catalyst may be simultaneously charged, or after the h-BN particles and the catalyst are dispersed or dissolved in the solvent, the coupling agent may be charged.

The mixing temperature can be, for example, approximately 20° C. or higher, approximately 25° C. or higher, approximately 40° C. or higher, or approximately 60° C. or higher, and approximately 80° C. or lower.

After mixing, if necessary, the surface-coated h-BN particle may be washed with deionized water, alcohol, or the like, or may be heated and dried.

The surface-coated h-BN particle of one embodiment has a layer containing a condensate of a coupling agent and formed on at least a portion of the surface of the h-BN particle. In this embodiment, the surface of the h-BN particle can include at least a portion of the (0001) plane.

The surface-coated h-BN particle of one embodiment can be obtained by the above-described production method.

The form of the surface-coated h-BN particles is basically the same as that of the h-BN particle used. Examples of the form of the surface-coated h-BN particles include, for example, primary particles of a needle shape, a flat-plate shape, and a scaly shape, and an agglomerate of these primary particles. In one embodiment, the surface-coated h-BN particles are flat-plate primary particles. In another embodiment, the surface-coated h-BN particle is an agglomerate of the primary particles.

An average major diameter of the surface-coated h-BN primary particles can be approximately 1.5 μm or more, approximately 2.0 μm or more, or approximately 2.5 μm or more, and approximately 25 μm or less, approximately 20 μm or less, or approximately 15 μm or less.

An average particle diameter of the surface-coated h-BN agglomerates can be approximately 20 μm or more, approximately 40 μm or more, or approximately 60 μm or more, and approximately 300 μm or less, approximately 250 μm or less, or approximately 200 μm or less.

In one embodiment, the angle of repose of the surface-coated h-BN particles, which is the flat-plate primary particles, is approximately 30 degrees or less, approximately 25 degrees or less, or approximately 20 degrees or less. The surface-coated h-BN particles of this embodiment have significantly higher flowability compared to untreated h-BN particles and have excellent handleability. The angle of repose is determined by the injection method described in examples.

The heat-dissipating resin composition of an embodiment includes the surface-coated h-BN particles described above. Since the surface-coated h-BN particle has good miscibility with other components of the heat-dissipating resin composition, high heat dissipation characteristics can be imparted to the heat-dissipating resin composition.

The blending amount of the surface-coated h-BN particles in the heat-dissipating resin composition can be appropriately determined in consideration of thermal conductivity, fluidity, mechanical strength, and the like desired for the intended use. For example, the blending amount of the surface-coated h-BN particles can be approximately 40 vol % or more, approximately 50 vol % or more, or approximately 55 vol % or more, and approximately 95 vol % or less, approximately 90 vol % or less, or approximately 80 vol % or less based on the solid content of the heat-dissipating resin composition. In the present disclosure, the vol % of the heat-dissipating resin composition is a value calculated using the blending amount (mass) and true density of each material.

The resin contained in the heat-dissipating resin composition can be appropriately selected in consideration of thermal conductivity, fluidity, mechanical strength, and the like desired for the intended use. As the resin, for example, a thermoplastic resin, a thermosetting resin, an elastomer, or the like can be used alone or in combination of two or more thereof.

Examples of the thermoplastic resin include polyolefins such as polyethylene and polypropylene, polyesters such as polyethylene terephthalate and polyethylene naphthalate, polycarbonate, polyamide, and polyphenylene sulfide.

Examples of the thermosetting resin include an epoxy resin, a (meth)acrylic resin, polyurethane, a silicone resin, an unsaturated polyester resin, a phenol resin, a melamine resin, and a polyimide resin.

An epoxy resin can be advantageously used from the viewpoint of moldability, adhesiveness to other members, insulation properties, and the like. Examples of the epoxy resin include a bisphenol A epoxy resin, a bisphenol F epoxy resin, a cresol novolac epoxy resin, a phenol novolac epoxy resin, an alicyclic aliphatic epoxy resin, and a glycidyl-aminophenol-based epoxy resin.

Examples of the elastomer include silicone rubber, isoprene rubber, butadiene rubber, styrene butadiene rubber, chloroprene rubber, ethylene propylene rubber, ethylene propylene diene rubber, nitrile rubber, acrylonitrile butadiene rubber (NBR), hydrogenated NBR, acrylic rubber, urethane rubber, fluorine-based rubber, and natural rubber.

The blending amount of the resins in the heat-dissipating resin composition can be appropriately determined in consideration of thermal conductivity, fluidity, mechanical strength, and the like desired for the intended use. For example, the blending amount of the resins can be approximately 5 vol % or more, approximately 10 vol % or more, or approximately 20 vol % or more, and approximately 60 vol % or less, approximately 50 vol % or less, or approximately 45 vol % or less based on the solid content of the heat-dissipating resin composition.

The heat-dissipating resin composition may further contain additives such as a dispersion auxiliary, a flame retardant, a pigment, a dye, a filler other than the surface-coated h-BN particles, a reinforcing material, a leveling agent, a coupling agent, an antifoaming agent, a heat stabilizer, a light stabilizer, a crosslinking agent, a thermo-curing agent, a photocuring agent, a curing accelerator, a tackifier, a plasticizer, a reactive diluent, and a solvent. The blending amount of these additives can be appropriately determined within a range in which characteristics desired for the intended use are not impaired.

In one embodiment, the heat-dissipating resin composition contains a dispersion auxiliary. In this embodiment, the dispersion auxiliary is effectively adsorbed to the surface-coated h-BN particles, and the surface-coated h-BN particles can be more uniformly dispersed in the heat-dissipating resin composition. Examples of the dispersion auxiliary include DISPERBYK-145 (BYK Japan K K, Amagasaki-shi, Hyogo-ken, Japan), DISPERBYK-108, and DISPERBYK-2008. The blended amount of the dispersion auxiliaries is approximately 0.1 parts by mass or more, approximately 0.5 parts by mass or more, or approximately 1 part by mass or more, and approximately 20 parts by mass or less, approximately 10 parts by mass or less, or approximately 5 parts by mass or less with respect to 100 parts by mass of the h-BN particles.

The heat-dissipating resin composition can be used in various forms such as a sheet, a film, grease, a sealant, and a molded article. The heat-dissipating resin composition may have insulating properties in addition to thermal conductivity.

In one embodiment, the heat-dissipating resin composition is in the form of a thermally conductive sheet. The thermally conductive sheet can be obtained by applying the heat dissipation resin composition onto a liner using a bar coater, a knife coater, or the like, and drying or curing the heat-dissipating resin composition, as necessary. A thermally conductive sheet can also be obtained by extrusion molding the heat-dissipating resin composition.

The thickness of the thermally conductive sheet may be appropriately adjusted according to the intended use and is not particularly limited. The thickness of the thermally conductive sheet can be, for example, approximately 80 μm or more, approximately 100 μm or more, or approximately 150 μm or more, and approximately 400 μm or less, approximately 350 μm or less, or approximately 300 μm or less.

In one embodiment, the thermal conductivity of the thermally conductive sheet is, for example, approximately 4.5 W/m·K or more, approximately 5.0 W/m·K or more, or approximately 5.5 W/m·K or more. The upper limit value of the thermal conductivity is not particularly limited, and can be, for example, approximately 20 W/m·K or less, approximately 18 W/m·K or less, or approximately 15 W/m·K or less. The thermal conductivity is determined by a laser flash method. The thermally conductive sheet having such thermal conductivity can be suitably used for, for example, a power module of an electric vehicle (EV).

The thermally conductive sheet may have adhesiveness. For example, a thermally conductive sheet having adhesiveness can be obtained by appropriately selecting a binder resin and using a tackifier, a crosslinking agent, or the like as necessary. When an epoxy resin is used as the binder resin, it can also be used as a thermally conductive adhesive sheet of a heating adhesion type.

The thermally conductive sheet can be suitably used for, for example, a heat-dissipating articles that is disposed to fill a gap between a heat-generating components such as IC chips used in vehicles such as electric vehicles (EVs), home appliances, computer equipment, and the like, and a heat-dissipating component such as a heat sink or a heat pipe, thereby efficiently transferring the heat generated from the heat-generating component to the heat-dissipating component, particularly, a heat-dissipating article used in power modules.

### EXAMPLES

In the following examples, specific embodiments of the present disclosure are illustrated, and the present invention is not limited thereto. All parts and percentages are by mass unless otherwise stated. Numerical values inherently include errors due to measurement principles and measurement devices. The numerical value is indicated by a significant number on which normal rounding processing has been performed.

Materials, reagents, and the like used in examples and comparative examples are shown in Table 1.

TABLE 1

| Product name or | | | |
|---|---|---|---|
| abbreviation | Category | Description | Manufacturer |
| P015 | h-BN particle | 3M (trade name) boron nitride | 3M Technical Ceramics |
| | | cooling filler Platelets 015, flat-plate, | (Kempten, Bayer, |
| | | particle size(D₅₀): 15 μm | Germany) |
| CFA150 | h-BN particle | 3M (trade name) boron nitride | 3M Technical Ceramics |
| | | cooling fillerAgglomerates CFA | (Kempten, Bayer, |
| | | 150, agglomerates, particle | Germany) |
| | | size(D₅₀): 55 to 115 μm | |
| S-50 | AIN particle | ANF-S-50, spherical aluminum | MARUWA CO., LTD. |
| | | nitride particle, | (Owariasahi-shi, Aichi, |
| | | particle size (D₅₀): | Japan) |
| | | 50 to 60 μm | |
| AL-3200 | Coupling | Aluminum monoacetylacetonate | Matsumoto Fine |
| | agent | bis(ethyl acetoacetate), | Chemical Co., Ltd. |
| | | 76 mass % IPA solution | (Ichikawa-shi, Chiba, |
| | | | Japan) |
| iOct-TMS | Coupling | Isooctyltrimethoxysilane | Gelest nc. |
| | agent | | (Morisville, PA, USA) |
| TEOS | Coupling | Tetraethyl orthosilicate, | FUJIFILM Wako Pure |
| | agent | special grade | Chemical Corporation |
| | | | (Osaka-shi, Osaka, |
| | | | Japan) |
| KBM-5103 | Coupling | 3-acryloxypropyltrimethoxysilane | Shin-Etsu |
| | agent | | Chemical Co., Ltd. |
| | | | (Chiyoda-ku, Tokyo, |
| | | | Japan) |
| TC-401 | Coupling | Titanium tetraacetylacetonate, | Matsumoto Fine |
| | agent | 65 mass % IPA solution | Chemical Co., Ltd. |
| | | | (Ichikawa-shi, Chiba, |
| | | | Japan) |
| IPA | Solvent | Isopropyl alcohol, 1 grade | FUJIFILM Wako Pure |
| | | | Chemical Corporation |
| | | | (Osaka-shi, Osaka, |
| | | | Japan) |
| DI Water | Solvent | Deionized water, >12 MΩ | |
| m-XDA | Catalyst | m-xylylenediamine, special grade | FUJIFILM Wako Pure |
| | | | Chemical Corporation |
| | | | (Osaka-shi, Osaka, |
| | | | Japan) |
| EDA | Catalyst | Ethylenediamine, special grade | FUJIFILM Wako Pure |
| | | | Chemical Corporation |
| | | | (Osaka-shi, Osaka, |
| | | | Japan) |
| jER 807 | Epoxy resin | Liquid bisphenol F epoxy resin | Mitsubishi Chemical |
| | | | Corporation |
| | | | (Chiyoda-ku, Tokyo, |
| | | | Japan) |
| jER T | Epoxy curing | Modified aliphatic amine | Mitsubishi Chemical |
| | agent | | Corporation |
| | | | (Chiyoda-ku, Tokyo, |
| | | | Japan) |
| CY52-276A | Silicone resin | DOWSIL CY52-276, base resin of | Dow Chemical Japan |
| | | two-component silicone gel | Co., Ltd. |
| | | | (Shinagawa-ku, Tokyo, |
| | | | Japan) |
| DISPERBYK-145 | Dispersion | Polymer copolymer | BYK Japan KK |
| | auxiliary | | (Amagasaki-shi, Hyogo, |
| | | | Japan) |
| EOCN104S | Epoxy resin | Polyfunctional epoxy resin | Nippon Kayaku Co., Ltd. |
| | | | (Chiyoda-ku, Tokyo, |
| | | | Japan) |
| EXA-7250 | Epoxy resin | Polyfunctional narrow Mw epoxy | DIC Corporation |
| | | resin | (Chuo-ku, Tokyo, Japan) |
| PKHH | Toughening | Phenoxy resin | Gabriel Phenoxies. Inc. |
| | agent | | (Akron, Ohio, USA) |
| CG1400 | Epoxy curing | Amicure CG-1400, dicyandiamide- | Evonic Industries AG |
| | agent | based micronizing and curing agent | (Nordline-Essen, |
| | | | Westphalia, Germany) |
| BYK430 | Rheological | Liquid Rheology | BYK Japan KK |
| | Additives | Additives | (Amagasaki-shi, Hyogo, |
| | | | Japan) |
| TS-720 | Thixotropic | Fumed silica | Evonic Industries AG |
| | agent | | (Nordline-Essen, |
| | | | Westphalia, Germany) |
| MEK | Solvent | Methyl ethyl ketone | — |
| PMA | Solvent | Propylene glycol | — |
| | | monomethyl ether | |
| | | acetate | |

### 1. Viscosity

The viscosity of the resin composition containing untreated h-BN particles or surface-coated h-BN particles was measured. Before starting the viscosity measurement, pre-shearing was performed for 30 seconds under the same measurement conditions so that the measurement values were not affected by the shearing history. The measurement conditions were as follows.

Measurement device: RS1 type rheometer (HAAKE (trademark) rheometer, Thermo Fisher Scientific Inc., Minato-ku, Tokyo, Japan)

Temperature: 23° C.

Cone diameter: 35 mm

Cone angle: 1 degree

Rotation speed: 1 degree/min

### 2. SEM Observation

SEM observations were performed to confirm the surface morphology of untreated h-BN particles or surface-coated h-BN particles. The measurement conditions were as follows.

Measurement device: Scanning electron microscope Regulus 8230 (Hitachi, Ltd., Chiyoda-ku, Tokyo, Japan)

Sample surface treatment: Osmium plasma coating

Acceleration voltage: 5 kV

Magnification: 1000 to 100,000

### 3. Angle of Repose

The angle of repose of the untreated h-BN particles and the surface-coated h-BN particles was measured by an injection method using a MT-1000 type multi-tester (SEISHIN ENTERPRISE Co., Ltd, Shibuya-ku, Tokyo, Japan). The h-BN particles were passed through a sieve and dropped onto the stage, and the angle at which the particles spilled from the stage was taken as the angle of repose. The angle of repose was measured by rotating the stage by 120 degrees, and the average value of the angles of repose at 3 points was obtained.

### 4. Bulk Density

The bulk density of the untreated h-BN particles and the surface-coated h-BN particles was measured by the following procedure. 20 g of a sample was placed in a 100 mL glass measuring cylinder with a SUS spatula. The bulk density (D) was calculated from the mass W (g) of the sample and the volume V (cm³) read by the measuring cylinder by the following formula

D(g/cm³)=W(g)N(cm³) (1).

### 5. Thermal Conductivity

The thermal conductivity of a sheet of the resin composition containing surface-coated h-BN particles was measured by laser flash analysis (LFA) using HyperFlash (trademark) LFA 467 (NETZSCH Japan K. K., Yokohama-shi, Kanagawa, Japan).

The sheet was prepared by the following procedure. The untreated h-BN particles or the surface-coated h-BN particles were mixed with an amine-curable bisphenol F epoxy resin (jER 807 and jER T) at 23° C. for 2 minutes using a planetary centrifugal mixer ARE-310 (THINKY CORPORATION, Chiyoda-ku, Tokyo, Japan) to obtain a resin composition. The obtained resin composition was in the form of a paste, a clay, or a wet powder. These resin compositions were pressed by sandwiching them between two acrylic plates having a thickness of 8 mm at an interval of 1 mm, and the two plates were fastened with four screws at corner portions. The sheet samples were cured stepwise for 1 hour at room temperature, 3 hours at 120° C., and 1 hour at 150° C. The cured sheet was cut into a 10 mm×10 mm square to prepare three measurement samples. The volume of the measurement sample was calculated by multiplying the thickness and the area. The thickness was measured with a contact thickness meter, and the area was calculated from the photographic image to reduce volume errors. The photographic image was cropped and calibrated with scale (conversion from pixels to mm scale). Thereafter, the photographic image was converted into a monochrome image and binarized to calculate a region. The density was calculated from mass and volume, and volume was calculated from thickness and area. Before the LFA measurement, a thin graphite layer was formed by spraying on the measurement sample.

In the LFA measurement, the bottom surface was irradiated with a pulse of light (xenon flash lamp, 230 V, duration of 20 to 30 μs) at 23° C., and then the temperature of the upper surface of the measurement sample was measured with an InSb IR detector. The thermal diffusivity was then calculated from the fit of the thermogram using a Cowan method. The thermal conductivity was obtained by multiplying the density, specific heat, and half value period by thermal diffusivity (a) calculated from the sample thickness. A specific heat (Cp) was determined using the signal height compared to that of the reference material. The thermal conductivity was an average of measurement values of a total of nine shots obtained by performing three shots on each of three measurement samples obtained from one resin composition. Error bars correspond to ±σ.

### 6. Dielectric Breakdown Voltage

The obtained resin composition was applied onto a PET film using a gap coater having a gap of 330 μm. The coating film was dried in a hot air dryer at 110° C. for 2 minutes to obtain an uncured sheet. Two sheets were bonded in advance with a thermal laminator at approximately 70° C., and then, in order to cure the sheets, the sheets were pressed at 180° C. for 20 minutes at a pressure of approximately 5 MPa to prepare a measurement sample. The dielectric breakdown voltage was measured using HAT-300-100R available from Nikka Techno Service Co., Ltd. The value of the dielectric breakdown voltage was an average value obtained by performing measurement three times at a speed of 0.5 kV/s in an air atmosphere at different points of the measurement sample.

### 7. Peeling Force

The uncured sheet obtained in the same procedure as in the dielectric breakdown voltage test was sandwiched between two copper strips (length: 100 mm, width: 10 mm, thickness: 38 μm), and the sheet was pressed at 180° C. for 20 minutes at a pressure of approximately 5 MPa to prepare a measurement sample. Two copper strips of the prepared measurement sample were each fixed with a test piece holder, and a T-type peeling test was performed at room temperature and a peeling rate of 20 mm/min using a tensile tester (Tensilon (trade name) universal material testing machine, model number: RTC-1325A, A&D Company, Limited, Toshima-ku, Tokyo, Japan) to measure a peeling force.

### 8. Oil Absorption

Oil absorption of the surface-coated h-BN particles was measured by the following procedure. 1 g of a sample was placed on a glass plate, and 4 or 5 drops of linseed oil (Wako first grade) was gradually added from a burette. In each case, the linseed oil was kneaded into the sample with a pallet knife. These operations were repeated, and the linseed oil was added dropwise until the linseed oil and a lump of a sample were formed. After the lump was formed, the linseed oil was added dropwise and completely kneaded. By repeating these operations, an end point was a point where a paste containing the linseed oil and the sample was able to be spread with a palette knife without cracking or becoming ragged, and was smooth enough to lightly adhere to a glass plate. The oil absorption was recorded in units of mL per 100 g of sample.

Preparation of Surface-Coated h-BN Particle

The surface-coated h-BN particles of examples and comparative examples described below were prepared by the following procedure. The catalyst was dissolved in a mixed solvent of IPA and DI water, and the h-BN particle was then added to obtain a dispersion A. In order to suppress the reaction of the coupling agent, the coupling agent was diluted with IPA to obtain a solution B. The dispersion A was prepared and then mixed for at least 10 minutes. The solution B was added to the dispersion A and the obtained solution was mixed using a rotary mixer at room temperature overnight at about 150 rpm. The solution was filtered through a Kiriyama No. 4 filter paper (pore size 1 μm) and the filtered solid was washed several times with IPA. After filtration, the surface-coated h-BN particle was dried in a hot air dryer at 80° C. for 3 hours, followed by a vacuum dryer equipped with a rotary pump at 80° C. for 3 hours to remove a residual solvent. The particles obtained after drying were loosely agglomerated. The agglomerate was pulverized to obtain a surface-coated h-BN particle.

### Preparation of Resin Composition

The resin compositions of examples and comparative examples described below were prepared by the following procedure. The untreated h-BN particles or the surface-coated h-BN particles were mixed with a binder resin, optionally, an additive, a solvent, and/or a spherical aluminum nitride (AlN) particle at a rotation speed of 2000 rpm and 23° C. for 2 minutes using a planetary centrifugal mixer ARE-310 (THINKY CORPORATION, Chiyoda-ku, Tokyo, Japan) to obtain a resin composition.

### Examples 1 to 8

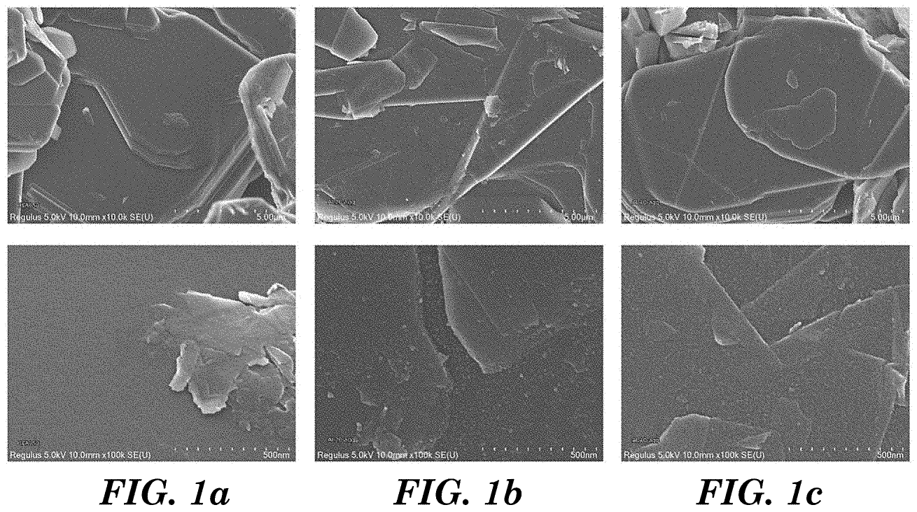

Surface-coated h-BN particles were prepared with the composition shown in Table 2. FIGS. 1(a) to 1(c) are SEM photographs (upper row: magnification 10,000, lower row: magnification 100,000) of untreated h-BN particles (CFA 150, agglomerates) (a), and surface-coated h-BN particles in Example 4 (b) and Example 5 (c).

TABLE 2
(numerical values are in parts by mass)

| | Dispersion A | | | | | | | |
|---|---|---|---|---|---|---|---|---|
| | | | Catalyst | | | Solution B | | |
| | h-BN particle | | m-XDA | IPA | DI Water | Coupling agent | | IPA |
| Example 1 | P015 | 50 | 1.36 | 100 | 200 | AL-3200 | 13.16 | 96.84 |
| Example 2 | (Primary | 50 | 1.36 | 100 | 200 | (76 mass% IPA | 26.32 | 93.68 |
| | particles) | | | | | solution) | | |
| Example 3 | | 5 | 0.136 | 20 | 20 | iOct-TMS | 3.38 | — |
| Example 4 | CFA150 | 5 | 0.136 | 10 | 20 | AL-3200 | 1.32 | 8.68 |
| Example 5 | (agglomerate) | 20 | 0.544 | 40 | 80 | (76 mass% IPA | 10.53 | 37.46 |
| | | | | | | solution) | | |
| Example 6 | | 15 | 0.408 | 60 | 60 | iOct-TMS | 0.75 | — |
| Example 7 | | 15 | 0.408 | 60 | 60 | | 3.00 | — |
| Example 8 | | 15 | 0.408 | 60 | 60 | | 9.00 | — |

### Examples 9 to 10, Comparative Examples 1 and 2

An epoxy-based resin composition having the composition shown in Table 3 was prepared. The measurement results of the viscosity of the resin composition are shown in Table 3.

TABLE 3
(numerical values of composition are in arts by mass)

| | | | | | | | Viscosity [Pa•s] | | |
|---|---|---|---|---|---|---|---|---|---|
| | | | | | | | Shear rate | | |
| | h-BN particle | | Binder resin | | Additive | | 25 [1/s] | 50 [1/s] | 100 [1/s] |
| Comparative | P015 | 3.00 | jER 807 | 7.00 | DISPER | — | 48.91 | 42.08 | 35.69 |
| Example 1 | | | | | BYK-145 | | | | |
| Comparative | | 3.00 | | 6.97 | | 0.03 | 46.26 | 40.70 | 34.46 |
| Example 2 | | | | | | | | | |
| Example 9 | Example 1 | 3.00 | | 6.97 | | 0.03 | 41.95 | 37.30 | 31.68 |
| Example 10 | Example 2 | 3.00 | | 6.97 | | 0.03 | 40.11 | 35.89 | 31.68 |

### Examples 11 and 12, Comparative Example 3

A silicone-based resin composition having the composition shown in Table 4 was prepared. The measurement results of the viscosity of the resin composition are shown in Table 4.

TABLE 4
(numerical values of composition are in parts by mass)

| | | | | | Viscosity [Pa•s] | | |
|---|---|---|---|---|---|---|---|
| | | | | | Shear rate | | |
| | h-BN particle | | Binder resin | | 25 [1/s] | 50 [1/s] | 100 [1/s] |
| Comparative | P015 | 1.00 | CY52- | 4.00 | 2.37 | 2.35 | 2.33 |
| Example 3 | | | 276A | | | | |
| Example 11 | Example 2 | 1.00 | | 4.00 | 2.20 | 2.15 | 2.17 |
| Example 12 | Example 3 | 1.00 | | 4.00 | 2.15 | 2.12 | 2.11 |

### Examples 13 to 15, Comparative Example 4

A resin composition having the composition shown in Table 5 was prepared.

TABLE 5
(numerical values are in parts by mass)

| | Particles | | | | | Binder resin | | | | | |
|---|---|---|---|---|---|---|---|---|---|---|---|
| | | | AIN | Additive | | EOCN | EXA- | | | Solvent | |
| | h-BN | | S-50 | TS-720 | BYK430 | 104S | 7250 | PKHH | CG1400 | MEK | PMA |
| Comparative | CFA150 | 3.90 | 1.84 | 0.05 | 0.30 | 0.20 | 1.15 | 0.15 | 0.12 | 3.76 | 1.26 |
| Example 4 | | | | | | | | | | | |
| Example 13 | Example 6 | 3.90 | 1.84 | 0.05 | 0.30 | 0.20 | 1.15 | 0.15 | 0.12 | 3.76 | 1.26 |
| Example 14 | Example 7 | 3.90 | 1.84 | 0.05 | 0.30 | 0.20 | 1.15 | 0.15 | 0.12 | 3.76 | 1.26 |
| Example 15 | Example 8 | 3.90 | 1.84 | 0.05 | 0.30 | 0.20 | 1.15 | 0.15 | 0.12 | 3.76 | 1.26 |

The evaluation results of the resin composition sheets of Examples 13 to 15 and Comparative Example 4 are shown in Table 6.

TABLE 6

| | | | | | Dielectric | |
|---|---|---|---|---|---|---|
| | | | | | breakdown | |
| | | Density | LFA | | voltage | |
| | | (Measured | | Thermal | [kV] | Peeling |
| | Thickness | value/Calculated | | conductivity | (Insulation | force |
| | [μm] | value) | Diffusivity | [W/mK] | strength) | [N/cm] |
| Comparative | 167 | 1.92 (96.1%) | 8.12 | 13.67 | 10.0 (59.9 | 1.84 |
| Example 4 | | | | | kV/mm) | |
| Example 13 | 164 | 1.91 (95.7%) | 7.62 | 12.77 | 10.8 (65.9 | 1.83 |
| | | | | | kV/mm) | |
| Example 14 | 170 | 1.90 (95.3%) | 8.46 | 14.14 | 10.9 (64.1 | 1.91 |
| | | | | | kV/mm) | |
| Example 15 | 166 | 1.88 (94.4%) | 8.08 | 13.37 | 10.6 (63.9 | 1.90 |
| | | | | | kV/mm) | |

### Examples 16 to 21

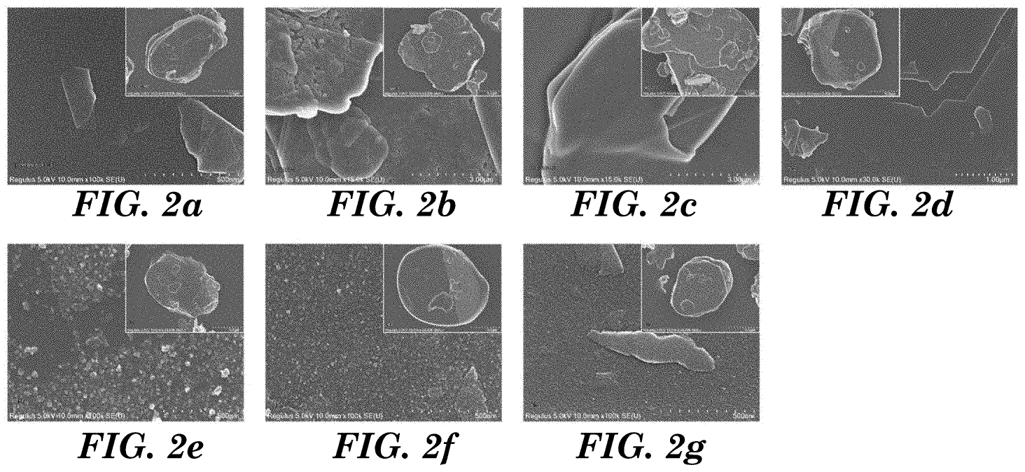

Surface-coated h-BN particles were prepared with the composition shown in Table 7. FIGS. 2(a) to 2(g) are SEM photographs (in upper frame: magnification 3,000, background: magnification 15,000, 30,000, or 100,000) of untreated h-BN particles (P015, primary particles) (a), and surface-coated h-BN particles in Example 16 (b), Example 17 (c), Example 18 (d), Example 19 (e), Example 20 (f), and Example 21 (g).

TABLE 7
(numerical values are in parts by mass)

Dispersion A

| | h-BN particle | Catalyst | | | Solution B | | |
|---|---|---|---|---|---|---|---|
| | P015 | m-XDA | IPA | DI Water | Coupling agent | | IPA |
| Example 16 | 5.00 | 0.136 | 20.0 | 20.0 | TEOS | 3.00 | — |
| Example 17 | 5.00 | 0.136 | 20.0 | 20.0 | KBM-5103 | 3.38 | — |
| Example 18 | 50.0 | 1.36 | 100 | 200 | TC401 | 15.39 | 94.61 |
| | | | | | (65 mass% IPA solution) | | |
| Example 19 | 50.0 | 1.36 | 100 | 200 | AL-3200 | 6.58 | 98.42 |
| Example 20 | 50.0 | 1.36 | 100 | 200 | (76 mass% IPA solution) | 13.16 | 96.84 |
| Example 21 | 50.0 | 1.36 | 100 | 200 | | 26.32 | 93.68 |

The evaluation results of the surface-coated h-BN particles of Examples 18 to 21 and the untreated h-BN particle (P015, primary particle) used in Comparative Example 1 are shown in Table 8.

TABLE 8

| | | | | Angle of repose (degrees) | | | |
|---|---|---|---|---|---|---|---|
| | | | | Observation | Observation | Observation | |
| | Mass | Volume | Bulk density¹⁾ | position | position | position | |
| | (g) | (cm³) | (g/cm³) | 0 degree | 120 degrees | 240 degrees | Average |
| (Comparative | 20.00 | 63 | 0.32 | 42 | 40 | 43 | 42 |
| Example 1) | | | | | | | |
| Example 18 | 20.06 | 56 | 0.36 | 24 | 23 | 26 | 24 |
| Example 19 | 20.04 | 49 | 0.41 | 19 | 20 | 19 | 19 |
| Example 20 | 20.00 | 45 | 0.44 | 14 | 19 | 15 | 16 |
| Example 21 | 20.09 | 53 | 0.38 | 26 | 31 | 25 | 27 |

¹⁾No tapping

### Comparative Examples 5 to 8

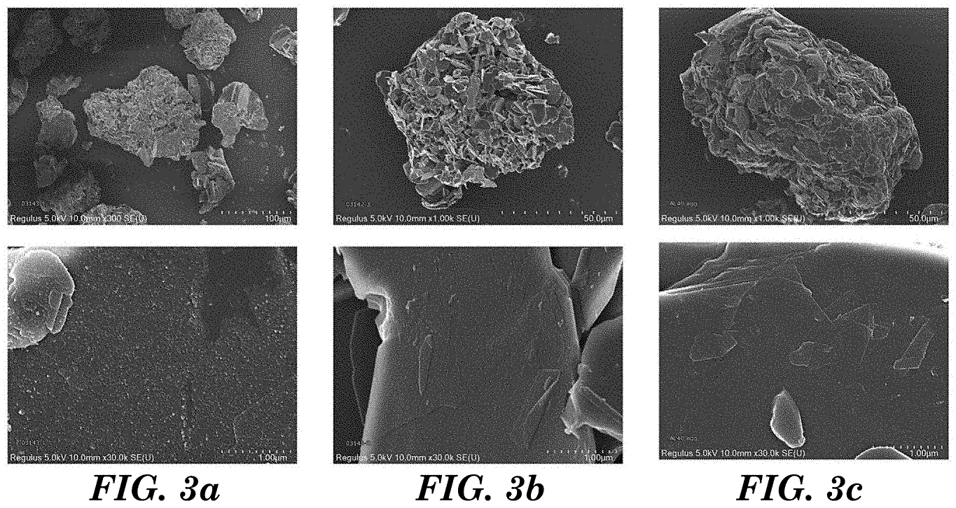

Surface-coated h-BN particles were prepared with the composition shown in Table 9. FIGS. 3(a) to 3(c) are SEM photographs (upper row: magnification 300 or 1,000, lower row: magnification 30,000) of surface-coated h-BN particles in Comparative Example 7 (a), Comparative Example 8 (b), and Example 5 (c).

TABLE 9
(numerical values are in parts by mass)

| | Dispersion A | | | | | | | Solution B | |
|---|---|---|---|---|---|---|---|---|---|
| | h-BN particle | | Catalyst | | IPA | DI Water | | Coupling agent | IPA |
| Comparative | P015 | 20 | NH₃ | 2.43 | 40 | 78.25 | AL-3200 | 10.53 | 37.46 |
| Example 5 | (Primary | | (28 mass% | | | | (76 mass% | | |
| | particles) | | aqueous | | | | IPA | | |
| | | | solution) | | | | solution) | | |
| Comparative | | 20 | EDA | 0.24 | 40 | 80 | | 10.53 | 37.46 |
| Example 6 | | | | | | | | | |
| Comparative | CFA150 | 20 | NH₃ | 2.43 | 40 | 78.25 | AL-3200 | 10.53 | 37.46 |
| Example 7 | (agglomerate) | | (28 mass% | | | | (76 mass% | | |
| | | | aqueous | | | | IPA | | |
| | | | solution) | | | | solution) | | |
| Comparative | | 20 | EDA | 0.24 | 10 | 80 | | 10.53 | 37.46 |
| Example 8 | | | | | | | | | |

### Examples 22 to 24, Comparative Examples 9 and 12

A resin composition having the composition shown in Table 10 was prepared.

TABLE 10
(numerical values are in parts by mass)

| | | | Additive | | | Volume%¹⁾ |
|---|---|---|---|---|---|---|
| | | | DISPER | Binder resin | | h-BN/ |
| | h-BN particle | | BYK-145 | jER 807 | jER T | Binder resin |
| Comparative | CFA150 | 1.2 | 0.012 | 0.966 | 0.222 | 35/65 |
| Example 9 | | | | | | |
| Example 22 | Example 4 | 1.2 | 0.012 | 0.966 | 0.222 | 35/65 |
| Example 23 | Example 5 | 1.2 | 0.012 | 0.966 | 0.222 | 35/65 |
| Comparative | CFA150 | 1.8 | 0.012 | 0.966 | 0.222 | 44/56 |
| Example 10 | | | | | | |
| Example 24 | Example 5 | 1.8 | 0.012 | 0.966 | 0.222 | 44/56 |
| Comparative | Comparative | 1.8 | 0.012 | 0.966 | 0.222 | 44/56 |
| Example 11 | Example 7 | | | | | |
| Comparative | Comparative | 1.8 | 0.012 | 0.966 | 0.222 | 44/56 |
| Example 12 | Example 8 | | | | | |

¹⁾Calculate specific gravity of h-BN particles as 2.26 and specific gravity of binder resin as 1.2

The evaluation results of the sheets of the resin compositions of Examples 22 to 24 and Comparative Examples 9 to 12 are shown in Table 11.

TABLE 11

| | | | LFA | |
|---|---|---|---|---|
| | | | | Thermal conductivity |
| | Thickness | Density (Measured | Diffusion | (± σ) |
| | [mm] | value/Calculated value) | rate (± σ) | [W/mK] |
| Comparative | 1.10 | 1.33 (84.6%) | 2.31 ± 0.03 | 3.20 ± 0.10 |
| Example 9 | | | | |
| Example 22 | 1.15 | 1.41 (90.1%) | 2.80 ± 0.10 | 4.25 ± 0.15 |
| Example 23 | 1.13 | 1.36 (86.6%) | 2.85 ± 0.22 | 4.22 ± 0.38 |
| Comparative | 1.62 | 1.47 (88.1%) | 3.58 ± 0.11 | 5.24 ± 0.03 |
| Example 10 | | | | |
| Example 24 | 1.41 | 1.46 (87.3%) | 4.97 ± 0.18 | 7.23 ± 0.40 |
| Comparative | 1.42 | 1.42 (85.2%) | 3.30 ± 0.15 | 4.68 ± 0.10 |
| Example 11 | | | | |
| Comparative | 1.42 | 1.38 (82.7%) | 3.47 ± 0.05 | 4.91 ± 0.07 |
| Example 12 | | | | |

The oil absorption of the surface-coated h-BN particles of Example 2, Comparative Example 5, and Comparative Example 6 are shown in Table 12. The low oil absorption suggests that the coating of the surface-coated h-BN particles is smoother and that other materials are more compatible with the surface of the surface-coated h-BN particles when mixed with other materials such as resins. Such surface properties of the surface-coated h-BN particles are considered to contribute to further enhancing the thermal conductivity of the composite material when mixing the surface-coated h-BN particles with other materials to form a composite material.

TABLE 12

| | Oil absorption |
|---|---|
| | [mL/100 g] |
| Example 2 | 102 |
| Comparative Example 5 | 112 |
| Comparative Example 6 | 112 |

It is apparent to those skilled in the art that various modifications can be made to the above embodiments and examples without departing from the basic principle of the present invention. In addition, it is apparent to those skilled in the art that various modifications and variations of the present invention can be implemented without departing from the spirit and scope of the present invention.

What is claimed is:

1. A surface-coated hexagonal boron nitride particle comprising a layer containing a condensate of a coupling agent formed on at least a portion of a surface of a hexagonal boron nitride particle, wherein the surface of the hexagonal boron nitride particle includes at least a portion of a (0001) plane.

2. The surface-coated hexagonal boron nitride particle according to claim 1, wherein the hexagonal boron nitride particle is a flat-plate primary particle.

3. The surface-coated hexagonal boron nitride particle according to claim 2,
wherein an angle of repose is 30 degrees or less.

4. The surface-coated hexagonal boron nitride particle according to claim 1, which is an agglomerate of primary particles.

5. The surface-coated hexagonal boron nitride particle according to claim 1, wherein the coupling agent contains at least one element selected from the group consisting of aluminum, silicon, titanium, and zirconium.

6. A heat-dissipating resin composition comprising a surface-coated hexagonal boron nitride particle according to claim 1, wherein the surface-coated hexagonal boron nitride particle has a layer containing a condensate of a coupling agent formed on at least a portion of a surface of the hexagonal boron nitride particle, and the surface of the hexagonal boron nitride particle includes at least a portion of a (0001) plane.

7. A method for producing a surface-coated hexagonal boron nitride particle, the method comprising mixing a hexagonal boron nitride particle (a), a coupling agent (b), and a catalyst (c) having a polar group and an aromatic ring in a solvent to form a layer containing a condensate of the coupling agent on at least a portion of a surface of the hexagonal boron nitride particle.

8. The method according to claim 7, wherein the surface of the hexagonal boron nitride particle includes at least a portion of a (0001) plane.

9. The method according to claim 7, wherein the hexagonal boron nitride particle is a flat-plate primary particle.

10. The method according to claim 7, wherein the hexagonal boron nitride particle is an agglomerate of primary particles.

11. The method according to claim 7, wherein the coupling agent contains at least one element selected from the group consisting of aluminum, silicon, titanium, and zirconium.

12. The method according to claim 7, wherein the polar group of the catalyst is an amino group.

13. The method according to claim 7, wherein the aromatic ring of the catalyst is a benzene ring.

14. The method according to claim 7, wherein the coupling agent is used in an amount from 10 parts by mass to 70 parts by mass per 100 parts by mass of the hexagonal boron nitride particles.
